(19) United States
(12) Patent Application Publication
(10) Pub. No.: US 2025/0296326 A1
(43) Pub. Date: Sep. 25, 2025

(54) DISCHARGE ELEMENT SUBSTRATE AND RECORDING APPARATUS

(71) Applicant: CANON KABUSHIKI KAISHA, Tokyo (JP)

(72) Inventors: MASASHI FUKUDA, Oita (JP); TOSHIO NEGISHI, Kanagawa (JP)

(21) Appl. No.: 19/083,906

(22) Filed: Mar. 19, 2025

(30) Foreign Application Priority Data
Mar. 22, 2024 (JP) 2024-046218

(51) Int. Cl. B41J 2/14

(52) U.S. Cl. CPC B41J 2/14072

(57) ABSTRACT

Provided is a discharge element substrate, including: a plurality of discharge elements configured to discharge liquid housed in a liquid chamber from a discharge port by energy generated by an energy element provided to a substrate; a first electrode configured to apply voltage to the plurality of discharge elements; a selection circuit configured to select any one of the plurality of discharge elements; and a second electrode configured to apply voltage to the discharge element selected by the selection circuit such that the discharge element is caused to discharge liquid. The plurality of discharge elements are arranged along a first direction. The first electrode is connected to the plurality of discharge elements in common along the first direction of the substrate.

### BACKGROUND OF THE INVENTION

### Field of the Invention

The present invention relates to a discharge element substrate and a recording apparatus.

### Description of the Related Art

A recording apparatus such as a printer performs recording by discharging ink from a recording head including a discharge element substrate to a recording medium. The discharge element substrate includes an ink feeding port, a discharge element such as a heater, a drive circuit therefor, a power supply electrode as a terminal for connection with wiring, and a peripheral circuit. Ink is discharged from a discharge port by driving of the discharge element. In Japanese Patent Application Publication No. 2017-013412, in a discharge element substrate having a plurality of ink feeding ports, wiring for driving a heater is provided at a beam part that separates the plurality of ink feeding ports from one another. In Japanese Patent Application Publication No. 2017-013412, the lengths of wiring for driving a plurality of heaters are adjusted such that the magnitudes of electric energy supplied to heaters are made uniform to improve printing quality.

### SUMMARY OF THE INVENTION

In the configuration in Japanese Patent Application Publication No. 2017-013412, the magnitudes of electric energy for driving individual heaters are made uniform, but the distance between the heater and the power supply electrode is several hundreds of um, and hence wiring resistance occurs accordingly. Due to voltage drop caused by the wiring resistance, electric energy for driving a heater is lost.

The present invention has been made in view of the above-mentioned problem, and it is an object thereof to improve efficiency of energy for driving a discharge element in a discharge element substrate.

The present invention provides a discharge element substrate, comprising:
a plurality of discharge elements configured to discharge liquid housed in a liquid chamber from a discharge port by energy generated by an energy element provided to a substrate;
a first electrode configured to apply voltage to the plurality of discharge elements;
a selection circuit configured to select any one of the plurality of discharge elements; and
a second electrode configured to apply voltage to the discharge element selected by the selection circuit such that the discharge element is caused to discharge liquid, wherein:
the plurality of discharge elements are arranged along a first direction; and
the first electrode is connected to the plurality of discharge elements in common along the first direction of the substrate.
The present invention also provides a recording apparatus, comprising a recording head including a discharge element substrate, wherein:
the discharge element substrate comprises:
   a plurality of discharge elements configured to discharge liquid housed in a liquid chamber from a discharge port by energy generated by an energy element provided to a substrate;
   a first electrode configured to apply voltage to the plurality of discharge elements;
   a selection circuit configured to select any one of the plurality of discharge elements; and
   a second electrode configured to apply voltage to the discharge element selected by the selection circuit such that the discharge element is caused to discharge liquid, wherein:
the plurality of discharge elements are arranged along a first direction;
the first electrode is connected to the plurality of discharge elements in common along the first direction of the substrate; and
an image is recorded on a recording material by liquid discharged from the discharge element substrate.

According to the present invention, efficiency of energy for driving a discharge element in a discharge element substrate can be improved.

Further features of the present invention will become apparent from the following description of exemplary embodiments with reference to the attached drawings.

### BRIEF DESCRIPTION OF THE DRAWINGS

FIG. 1A is a plan view of a discharge element substrate according to Embodiment 1;

FIG. 1B is a partially enlarged plan view of the discharge element substrate according to Embodiment 1;

FIG. 1C is a partially enlarged plan view of the discharge element substrate according to Embodiment 1;

FIG. 1D is a cross-sectional view of the discharge element substrate according to Embodiment 1;

FIG. 2 is a schematic configuration diagram of a discharge element substrate according to a modification in which a configuration of an electrode pad has been changed;

FIG. 3 is a schematic configuration diagram of a discharge element substrate according to a modification in which a configuration of a power supply electrode has been changed;

FIG. 4A is a plan view of a discharge element substrate according to Embodiment 2;

FIG. 4B is a partially enlarged plan view of the discharge element substrate according to Embodiment 2;

FIG. 4C is a partially enlarged plan view of the discharge element substrate according to Embodiment 2;

FIG. 4D is a cross-sectional view of the discharge element substrate according to Embodiment 2;

FIG. 5 is a schematic configuration diagram of a discharge element substrate in which a configuration of an electrode pad has been changed from Embodiment 2;

FIG. 6 is a schematic configuration diagram of a discharge element substrate in which a configuration of a ground electrode has been changed from Embodiment 2;

FIG. 7 is a partially enlarged plan view of the vicinity of a discharge element in a discharge element substrate according to Embodiment 3;

FIG. 8 is a circuit configuration example of a discharge element substrate;

FIG. 9 is a configuration example illustrating a part of a recording head; and

FIG. 10 is a configuration example of a recording apparatus.

### DESCRIPTION OF THE EMBODIMENTS

Preferred embodiments of the present invention are exemplarily described in detail with reference to the drawings. Note that the dimensions, materials, shapes, and relative arrangements of components described in the embodiments are not intended to limit the scope of the present invention to only the ones unless otherwise specified. In the following description, the materials and shapes of members described once are the same in the subsequent description as in the first description unless otherwise described again. For configurations and steps that are not particularly illustrated or described, well-known technologies or publicly known technologies in the technical field can be applied. Furthermore, the present invention is not limited only to the embodiments, and not all combinations of features described in the embodiments are essentials for solutions to the present invention.

The following embodiments are preferably mainly applicable to a discharge element substrate to be used in an internal portion included in a printing apparatus (recording apparatus).

### Embodiment 1

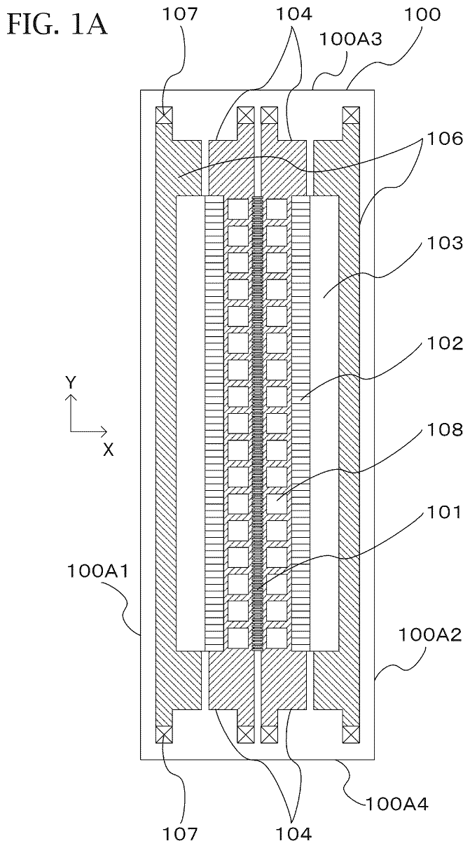

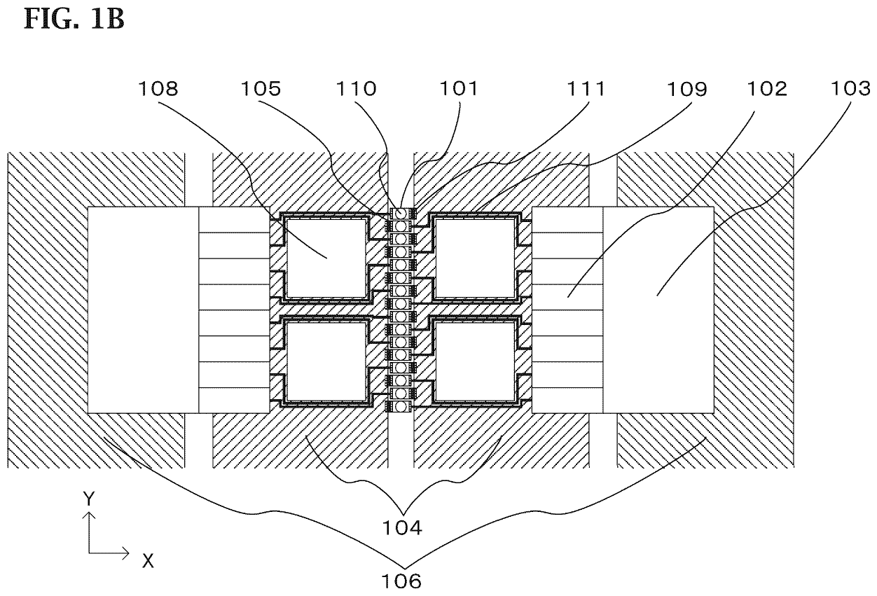

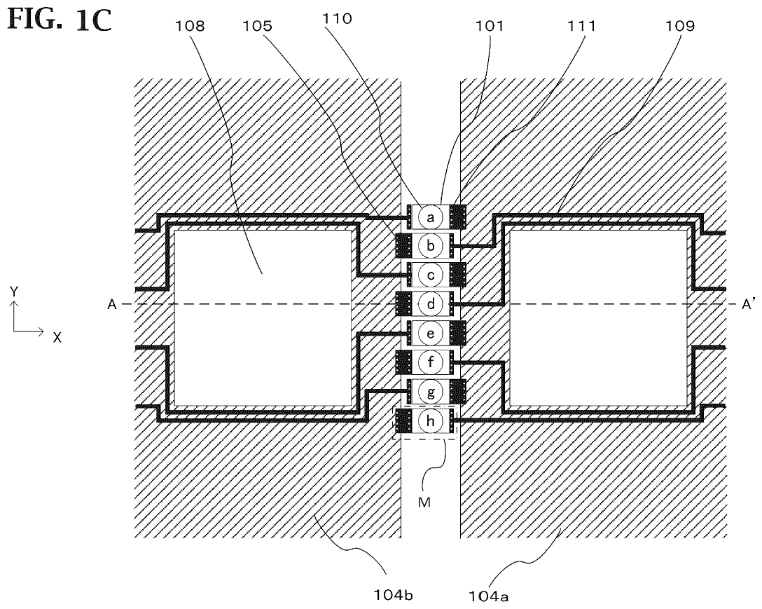

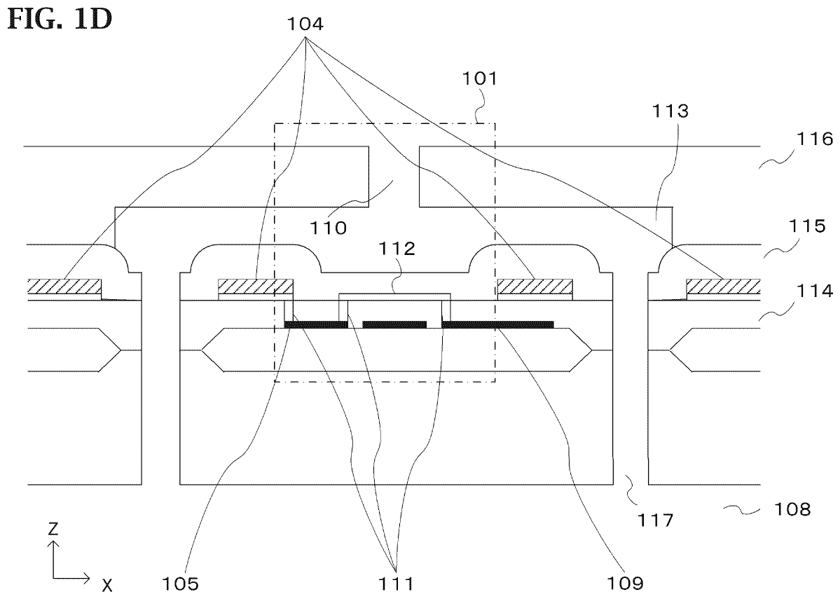

FIG. 1A to FIG. 1D are schematic configuration diagrams of a discharge element substrate 100 according to Embodiment 1. FIG. 1A is an overall plan view of the discharge element substrate 100. FIG. 1B and FIG. 1C are partially enlarged plan views of the vicinity of a discharge element 101 in FIG. 1A. FIG. 1D is a schematic configuration diagram of a cross section taken along the line A-A′ in FIG. 1C.

The discharge element substrate 100 includes discharge elements 101 as units for discharging liquid such as ink. The discharge element 101 includes an energy generation element 112 for generating energy, and the energy generation element 112 in the present embodiment is a heater for discharging ink by thermal energy. Note that the energy generation element 112 is not limited to a heater, and may be, for example, an ultrasonic element.

The discharge element 101 includes at least one discharge port 110, and discharges liquid housed in a liquid chamber 113 from the discharge port 110 by energy generated by the energy generation element 112. A recording apparatus selects an appropriate one of a plurality of discharge elements 101 on the basis of image information, and controls the discharge element 101 to discharge liquid, thereby being capable of forming a desired image on a recording material. For example, FIG. 1C illustrates eight discharge elements 101a to 101h. Of those, a cross section in a region corresponding to the discharge element 101h (part surrounded by dashed-dotted line M in FIG. 1C) is indicated by reference numeral 101 in FIG. 1D.

A plurality of drive circuits 102 for driving a plurality of discharge elements 101, respectively, are disposed in a row along a first direction along a first side of the discharge element substrate 100. The first direction is an up-down direction (Y direction) in FIG. 1A to FIG. 1C. A plurality of discharge elements 101 may be provided correspondingly to each drive circuit 102. Even when a plurality of discharge elements 101 correspond to one drive circuit 102, the plurality of discharge elements 101 are disposed side by side along the first direction. Note that, in the present embodiment, the arrangement direction of each component such as the discharge element 101 is along the direction of the side of the discharge element substrate 100, but is not limited thereto.

A selection circuit 103 is disposed along the first direction along the first side of the discharge element substrate 100. The selection circuit 103 can output a selection signal for selecting any one of a plurality of drive circuits 102, thereby selecting a discharge element 101 corresponding to a drive circuit 102. In this manner, by selecting a discharge element 101 to be driven in synchronization with a movement timing of the recording head, recording according to image information can be performed. A combination of a plurality of drive circuits 102 and a plurality of selection circuits 103 may be disposed such that a substantial arrangement density is smaller in the discharge element arrangement direction as compared to the plurality of discharge elements 101.

FIG. 1A illustrates a power supply electrode 104 for applying voltage to the energy generation element 112 in the discharge element 101. In the present embodiment, the power supply electrode 104 is provided so as to extend along the first side of the discharge element substrate 100. Two power supply electrodes 104 are provided side by side in the second direction. Note that, for the sake of convenience, in the following description, the Y direction in the figures is referred to as “first direction”, and the X direction is referred to as “second direction”. The second direction is a direction perpendicular to the first direction in the plane of the substrate. Furthermore, in the case where the discharge element substrate 100 is rectangular, a side along the first direction (side 100A1 or side 100A2) is referred to as “first side”, and a side along the second direction (side 100A3 or side 100A4) is referred to as “second side”. However, the shape of the discharge element substrate 100 is not limited to be rectangular. Furthermore, also in the case where the shape of the discharge element substrate 100 is rectangular, the direction of the side and the arrangement direction of each element do not always need to match each other.

As illustrated in FIG. 1B, power supply wiring 105 that forms a power supply path from the power supply electrode 104 to the energy generation element 112 of the discharge element 101 is provided correspondingly to the discharge element 101. On the substrate, the ground electrode 106 for applying ground voltage to the energy generation element 112 of the discharge element 101 is disposed. The widths of the power supply electrode 104 and the ground electrode 106 in the second direction (X direction) are different depending on heater current and a nozzle length but are assumed to be about 100 μm to 1,000 μm. Furthermore, a distance between the power supply electrode 104 and the ground electrode 106 is assumed to be about 5 μm to 10 μm.

In this case, at least one of the power supply electrode 104 and the ground electrode 106 may be what is called plane wiring. The plane wiring is wiring connected to a plurality of discharge elements in common. Typically, the plane wiring is formed with high wiring density so as to cover the entire predetermined region on the substrate, and provides electric connection to the plurality of discharge elements 101 in common. Furthermore, typically, the plane wiring is wiring that is formed in a planar shape (plane). By using the plane wiring, a wide wiring area is secured over the surface of the substrate, and hence wiring resistance can be suppressed. Furthermore, short wiring such as the power supply wiring 105 can be used to connect between a part of the plane wiring and the discharge element 101, and hence wiring resistance can be suppressed.

The thicknesses of the power supply electrode 104 and the ground electrode 106 are different depending on a film forming process but are assumed to be about 600 nm to 1,000 nm. The discharge element substrate 100 may be formed in a manner that a transistor constituting the drive circuit 102 is formed on the substrate and then the power supply electrode 104 is laminated.

As illustrated in FIG. 1A, in the present embodiment, in a plan view of the discharge element substrate 100, the drive circuit 102 and the power supply electrode 104 are disposed at overlapping positions, and the selection circuit 103 and the ground electrode 106 are disposed at overlapping positions. In this case, on a plurality of drive circuits 102, at least power supply wiring 105 connected to the power supply electrode 104 that does not drive a corresponding discharge element 101 may be disposed. Furthermore, on a plurality of selection circuits 103, at least wiring connected to the ground electrode 106 for driving a corresponding discharge element 101 may be disposed.

The power supply electrode 104 and the ground electrode 106 may be divided into two around the middle of the first side of the discharge element substrate 100. The number of divisions is not limited to two. At an edge part of the discharge element substrate 100, an electrode pad 107 for electrical connection to the outside is disposed. By applying voltage to the power supply electrode 104 or the ground electrode 106 from the outside through the electrode pad 107, power is supplied to the discharge element 101. Although not illustrated in FIG. 1A, a different electrode pad 107 that is not connected to the power supply electrode 104 is present on the discharge element substrate 100. Through this electrode pad 107, power is supplied to the drive circuit 102 or the selection circuit 103 from the outside and control signals are input and output.

Current flows through the power supply electrode 104 to each discharge element 101, and hence a wide structure with low resistance is advantageous (for example, the above-mentioned plane wiring). Here, the wide structure of an electrode needs to have a larger wiring area per area on the substrate than that of at least the conventional case. Furthermore, in the case where the power supply electrode 104 is divided as described above, it is preferred that the electrode pad 107 be provided correspondingly to each divided power supply electrode 104. When a distance between a corresponding electrode pad 107 and the power supply electrode 104 is made closer to that of the other electrode pads 107, the length from the electrode pad 107 to the discharge element 101 can be reduced. By configuring the power supply electrode 104 in this manner, voltage drop in the power supply electrode 104 can be sufficiently reduced.

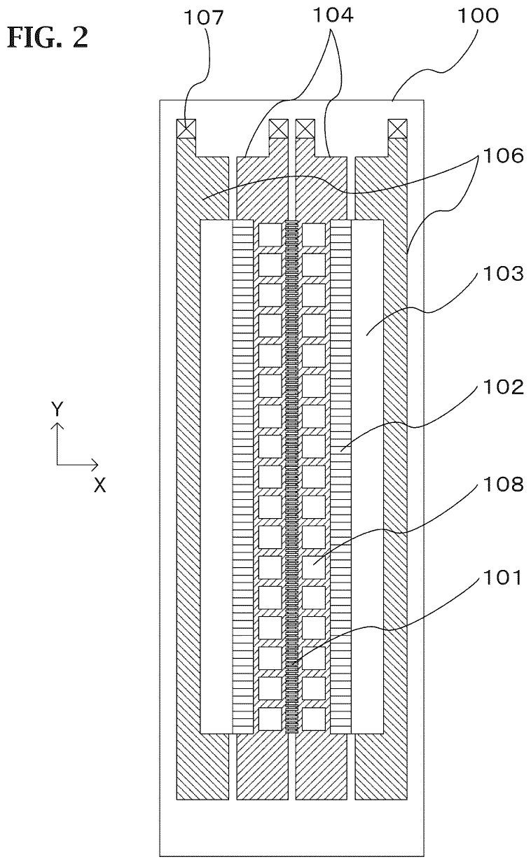

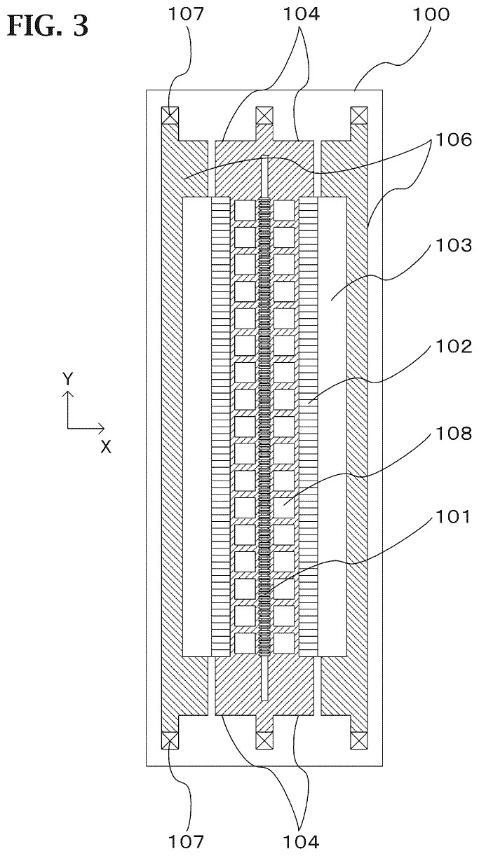

Furthermore, in FIG. 1A, the electrode pads 107 are disposed at the upper and lower edge parts of the discharge element substrate 100, but in a case where the power supply electrode 104 and the ground electrode 106 are not divided into two around the middle of the first side of the discharge element substrate 100, the electrode pads 107 may be disposed only on the upper or lower side as in FIG. 2. Furthermore, as illustrated in FIG. 3, a configuration in which adjacent power supply electrodes 104 are connected and a configuration in which the electrode pads 107 connected to the power supply electrodes 104 are used in common so as to reduce the number of terminals can be employed.

A feeding port 108 for supplying ink to the discharge element 101 is disposed correspondingly to the discharge element 101. The feeding port 108 is formed so as to pass through the discharge element substrate 100.

Referring to FIG. 1B, FIG. 1C, and FIG. 1D, a layout of the vicinity of the discharge element 101 in the discharge element substrate 100 is described. A plurality of feeding ports 108 are disposed in a row along the Y direction. A plurality of discharge elements 101 are disposed between a plurality of feeding ports 108. In each discharge element 101, a discharge port 110 for discharging ink is formed on the energy generation element 112.

As illustrated in FIG. 1B and FIG. 1C, two rows of power supply electrodes 104 are formed side by side in the X direction so as to sandwich a row formed by a plurality of discharge elements 101 (discharge element row). Similarly, two rows of ground electrodes 106 are formed side by side in the X direction so as to sandwich the discharge element row. Note that the two rows of ground electrodes 106 are disposed to sandwich the power supply electrode 104 in the X direction. Each power supply electrode 104 is disposed such that a distance from the discharge element 101 is smaller than each ground electrode 106. Furthermore, the power supply electrode 104 is disposed such that a distance from the discharge element row is smaller than the feeding port 108.

Each power supply electrode 104 is connected to a plurality of discharge elements 101 through the power supply wiring 105. Note that, as in FIG. 1D, the power supply electrode 104 and the discharge element 101 may be connected to the through hole 111 in addition to the power supply wiring 105. Furthermore, a plurality of drive circuits 102 are connected to a plurality of discharge elements 101 through the drive wiring 109. The through hole 111 is disposed at a connection part thereof. Note that, although not illustrated, the ground electrode 106 is connected to a plurality of drive circuits 102. Through the power supply wiring 105 and the drive wiring 109, power is supplied from a power source to the plurality of discharge elements 101.

In the present embodiment, as illustrated in FIG. 1D, the power supply wiring 105, the drive wiring 109, and a through hole 111 are formed in the base substrate 114, and the energy generation element 112 is formed on the substrate. Furthermore, it is preferred that a protective layer 115 for protecting the energy generation element 112 and the wiring be formed. In addition, a face plate 116 is provided on the substrate, and a liquid chamber 113 and a discharge port 110 are formed. In the base substrate 114, a connection port 117 for connecting the liquid chamber 113 and the feeding port 108 is provided.

As described above, the present embodiment employs a configuration in which each power supply electrode 104 is disposed near the discharge element 101 such that the power supply wiring 105 that connects the power supply electrode 104 and the discharge element 101 is short. In this manner, wiring resistance of the power supply wiring 105 can be reduced. As a result, voltage drop caused by the power supply wiring 105 can be reduced to improve the efficiency of power of the plurality of discharge elements 101.

Here, “power supply electrode 104 and discharge element 101 are disposed closely” is implemented by the following configurations in the present embodiment. A first configuration is a configuration in which a distance between each discharge element 101 and the power supply electrode 104 is smaller than a distance between each discharge element 101 and the ground electrode 106. A second configuration is a configuration in which the power supply electrode 104 is formed as plane wiring with high wiring density such that the shortest distance between the power supply electrode 104 and each discharge element 101 can be reduced. A third configuration is a configuration in which the power supply electrode 104 is formed along the first direction and the discharge elements 101 are also arranged along the first direction. A fourth configuration is a configuration in which two power supply electrodes 104 are formed in parallel along the first direction and sandwich a discharge element row. In this manner, a part of discharge elements 101 is connected to one power supply electrode 104 and the remaining part of discharge elements 101 is connected to the other power supply electrode 104, so that the discharge elements are distributed to the left and right sides. Then, by distributing the discharge elements 101 alternatingly or to the left and right sides in a group of a predetermined number of discharge elements 101, wiring with a margin can be implemented. To dispose the power supply electrode 104 closely to the discharge element 101, all the above-mentioned first to fourth configurations are not necessarily required, but it is preferred that a larger number of the configurations be satisfied.

Furthermore, by employing the following fifth configuration, the power supply electrode 104 can be more reliably disposed near the discharge element 101. Specifically, in a plan view of the discharge element substrate 100, a part of the power supply electrode 104 is included in a region of the discharge element 101. This corresponds to the configuration in FIG. 1D in which the power supply electrode 104 is included in the range of the discharge element 101 indicated by the broken line.

Here, in FIG. 1C, a plurality of discharge elements 101 arranged in a row are referred to as discharge elements 101a to 101h in this order from the upper edge. In this case, an odd-numbered element group (discharge elements 101a, 101c, 101e, and 101g) counted from the upper edge is defined as “first element group”, and an even-numbered element group (discharge elements 101b, 101d, 101f, and 101h) is defined as “second element group”. In this case, the first element group is connected to the right power supply electrode 104a through the power supply wiring 105, and the second element group is connected to the left power supply electrode 104b through the power supply wiring 105. In other words, in the present embodiment, discharge elements 101 included in a discharge element row are connected to different power supply electrodes 104 alternatingly. Furthermore, drive wiring 109 is connected to each discharge element 101 on a side where the power supply wiring 105 is not connected (that is, side where power supply electrode 104 is not connected).

In this manner, by distributing discharge elements 101 connected to the power supply electrodes 104, voltage drop can be sufficiently reduced. Note that the method of distributing the discharge elements 101 is not limited to the method of distributing the discharge elements 101 alternatingly one by one. For example, a method of distributing adjacent discharge elements two by two may be employed as described later. In addition, any method that can reduce wiring resistance as compared to the conventional case by distributing discharge elements 101 to appropriate different power supply electrodes 104 may be employed.

As described above, in the present embodiment, each power supply electrode 104 is disposed near the discharge element 101, so that the layout is implemented such that the power supply wiring 105 is short. Furthermore, in a discharge element row, each discharge element 101 is connected to a power supply electrode 104 different from an adjacent discharge element 101. As a result, voltage drop in each power supply electrode 104 and the power supply wiring 105 can be sufficiently reduced. In this manner, the efficiency of electric energy supplied to the plurality of discharge elements 101 is improved.

Note that the configuration in which the power supply electrode 104 and the discharge element 101 are disposed closely reduces the length of power supply wiring 105 that connects the power supply electrode 104 and the energy generation element 112 as compared to at least the conventional technology. Furthermore, in a top view, the power supply electrode 104 may be disposed to overlap a part of a region of the discharge element 101.

### Embodiment 2

In the present embodiment, an example where the layout of the power supply electrode 104 and the ground electrode 106 is different from Embodiment 1 is described. The same configurations as in Embodiment 1 are denoted by the same reference numerals, and descriptions thereof are omitted.

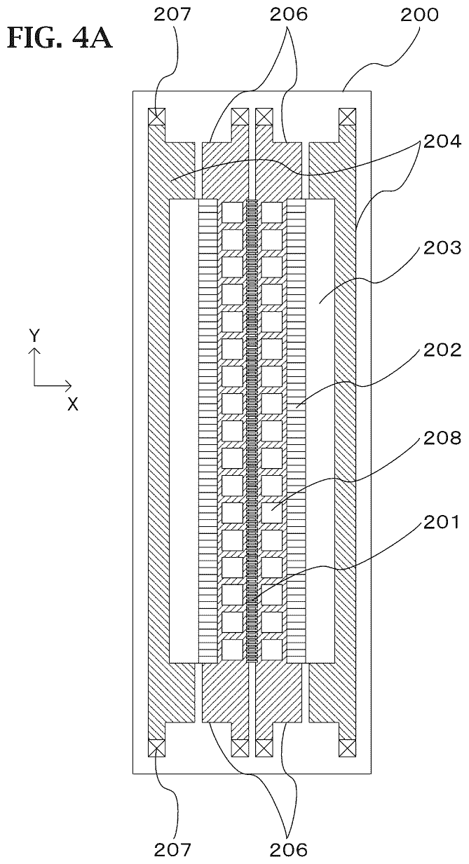

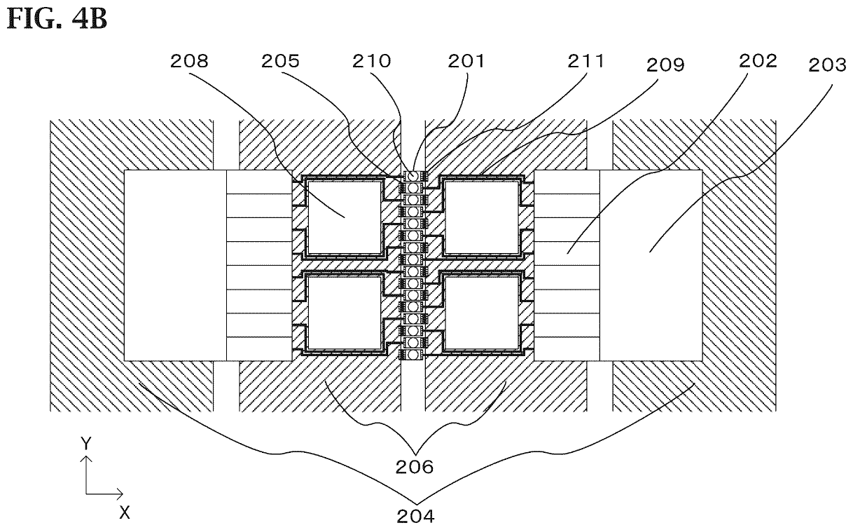

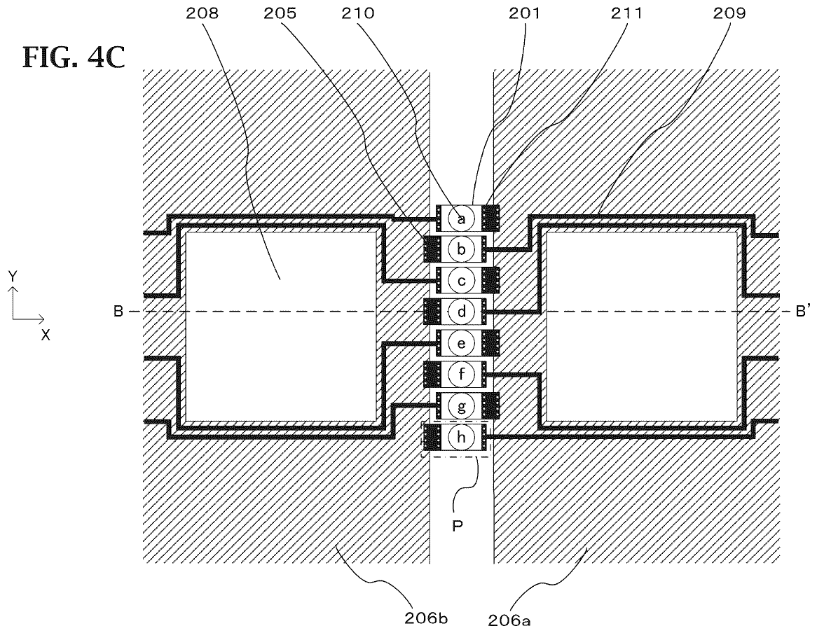

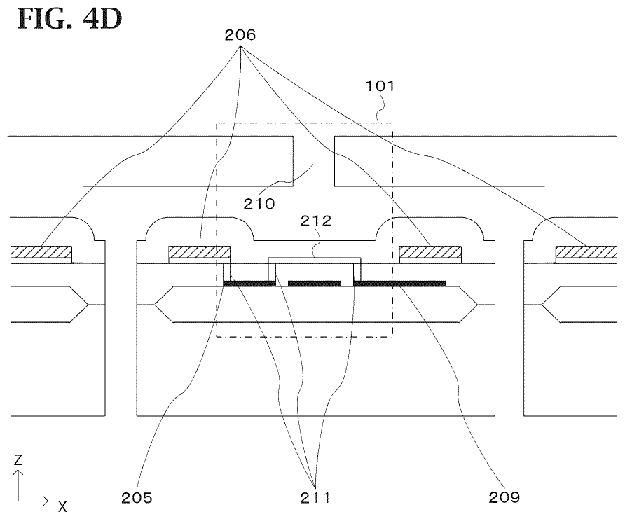

FIG. 4A to FIG. 4D are schematic configuration diagrams of a discharge element substrate 200 according to Embodiment 2. FIG. 4A is an overall plan view of the discharge element substrate 200. FIG. 4B and FIG. 4C are partially enlarged plan views of the vicinity of the discharge element 201 in FIG. 4A. FIG. 4D is a schematic configuration diagram of a cross section taken along the line B-B′ in FIG. 4C.

Similarly to Embodiment 1, in a row along the Y direction of the discharge element substrate 200, a plurality of discharge elements 201 and a plurality of drive circuits 202 corresponding to the plurality of discharge elements 201 are provided. Furthermore, a plurality of selection circuits 203 are also disposed along the Y direction. A combination of the drive circuit 202 and the selection circuit 203 is the same as in Embodiment 1.

FIG. 4A illustrates a power supply electrode 204 for supplying power to the energy generation element 212 in the discharge element 201. In the present embodiment, the power supply electrode 204 is provided so as to extend along the first side of the discharge element substrate 200. Furthermore, a ground electrode 206 for supplying ground voltage to the energy generation element 212 in the discharge element 201 is also disposed so as to extend along the first side. In FIG. 1A, in the X direction, the power supply electrode 104 is disposed on the inner side and the ground electrode 106 is disposed on the outer side. On the other hand, in FIG. 4A, the ground electrode 206 is disposed on the inner side and the power supply electrode 204 is disposed on the outer side.

As illustrated in FIG. 4B, power supply wiring 205 that forms a power supply path from the ground electrode 206 to the energy generation element 212 of the discharge element 201 is provided correspondingly to the discharge element 201. The widths of the power supply electrode 204 and the ground electrode 206 in the second direction (X direction) are different depending on heater current and a nozzle length but are assumed to be about 100 μm to 1,000 μm. Furthermore, a distance between the power supply electrode 204 and the ground electrode 206 is assumed to be about 5 μm to 10 μm. The thicknesses of the power supply electrode 204 and the ground electrode 206 are different depending on a film forming process but are assumed to be about 600 nm to 1,000 nm. The discharge element substrate 200 may be formed in a manner that a transistor constituting the drive circuit 202 is formed on the substrate and then the power supply electrode 204 is laminated.

As illustrated in FIG. 4A, in the present embodiment, in a plan view of the discharge element substrate 200, the drive circuit 202 and the ground electrode 206 are disposed at overlapping positions, and the selection circuit 203 and the power supply electrode 204 are disposed at overlapping positions. In this case, on a plurality of drive circuits 202, at least power supply wiring 205 connected to the ground electrode 206 that does not drive a corresponding discharge element 201 may be disposed. Furthermore, on a plurality of selection circuits 203, at least wiring connected to the power supply electrode 204 for driving a corresponding discharge element 201 may be disposed.

Similarly to Embodiment 1, the power supply electrode 204 and the ground electrode 206 may be divided into two or more in the Y direction. Furthermore, the matter that an electrode pad 207 is disposed at an edge part of the discharge element substrate 200 to apply voltage to the power supply electrode 204 or the ground electrode 206 and the matter that power is supplied to the drive circuit 202 and the selection circuit 203 through an electrode pad 207 (not shown) are the same as in Embodiment 1.

Furthermore, current flows through the power supply electrode 204 to each discharge element 201, and hence a wide structure with low resistance is advantageous. Typically, plane wiring as described in Embodiment 1 is employed. Furthermore, in a case where the power supply electrode 204 is divided, the electrode pad 207 is provided correspondingly to each divided power supply electrode 204, so that the length from the electrode pad 207 to the discharge element 201 can be reduced. By employing such a configuration of the power supply electrode 204, voltage drop in the power supply electrode 204 can be sufficiently reduced.

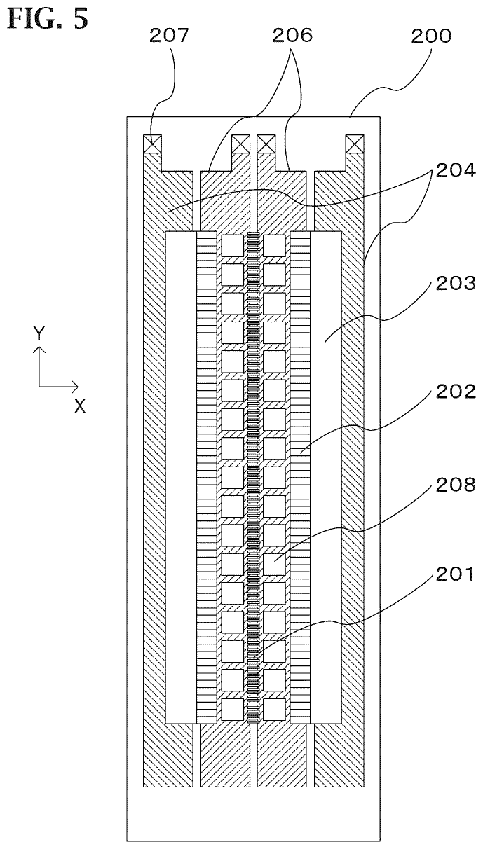

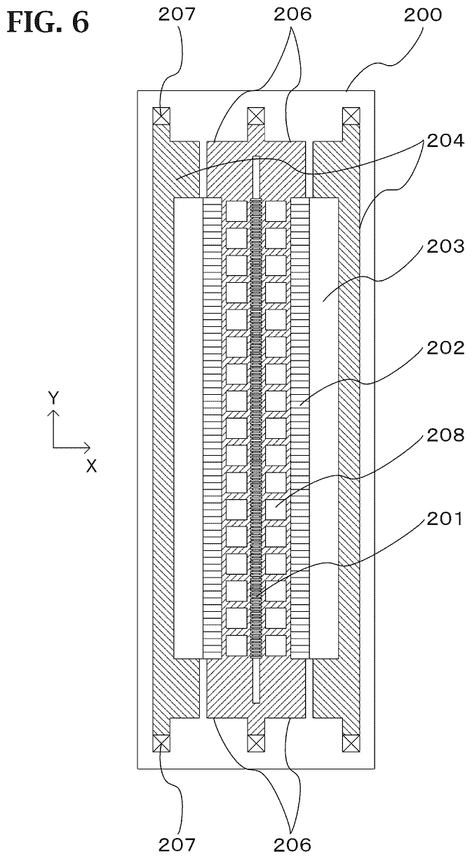

Furthermore, in FIG. 4A, the electrode pads 207 are disposed at the upper and lower edge parts of the discharge element substrate 200, but in a case where the power supply electrode 204 and the ground electrode 206 are not divided into two around the middle of the first side of the discharge element substrate 200, the electrode pads 207 may be disposed only on the upper or lower side as in FIG. 5. Furthermore, as illustrated in FIG. 6, a configuration in which adjacent ground electrodes 206 are connected and a configuration in which the electrode pads 207 connected to the ground electrodes 206 are used in common so as to reduce the number of terminals can be employed.

The feeding port 208 for supplying ink to a discharge element 201 is disposed correspondingly to the discharge element 201. The feeding port 208 is formed so as to pass through the discharge element substrate 200.

Referring to FIG. 4B, FIG. 4C, and FIG. 4D, a layout of the vicinity of the discharge element 201 in the discharge element substrate 200 is described. A plurality of feeding ports 208 are disposed in a row along the Y direction. A plurality of discharge elements 201 are disposed between a plurality of feeding ports 208. On each discharge element 201, a discharge port 210 for discharging ink is formed.

As illustrated in FIG. 4B and FIG. 4C, two rows of ground electrodes 206 are formed side by side in the X direction so as to sandwich a row formed by a plurality of discharge elements 201 (discharge element row). Similarly, two rows of power supply electrodes 204 are formed side by side in the X direction so as to sandwich the discharge element row. Note that the two rows of power supply electrodes 204 are disposed so as to sandwich the ground electrode 206 in the X direction. Each ground electrode 206 is disposed such that a distance from the discharge element 201 is smaller than each power supply electrode 204. Furthermore, the ground electrode 206 is disposed such that a distance from the discharge element row is smaller than the feeding port 208.

Each ground electrode 206 is connected to a plurality of discharge elements 201 through the power supply wiring 205. Note that, in FIG. 4D, the ground electrode 206 and the energy generation element 212 may be connected through the through hole 211 in addition to the power supply wiring 205. Furthermore, a plurality of drive circuits 202 are connected to a plurality of discharge elements 201 through the drive wiring 209. The through hole 211 is disposed at a connection part thereof. Note that, although not illustrated, the power supply electrode 204 is connected to a plurality of drive circuits 202. Through the power supply wiring 205 and the drive wiring 209, power is supplied from a power source to the plurality of energy generation elements 212.

As described above, in the present embodiment, each ground electrode 206 is disposed near the discharge element 201, so that the power supply wiring 205 that connects the ground electrode 206 and the discharge element 201 is short. In this manner, wiring resistance in the power supply wiring 205 can be reduced. As a result, voltage drop caused by the power supply wiring 205 can be reduced, and the efficiency of power of the plurality of discharge elements 201 can be improved.

Here, also in FIG. 4C, similarly to the case in FIG. 1C, a plurality of discharge elements 201 are classified into a first element group (discharge elements 201a, 201c, 201e, and 201g) and a second element group (discharge elements 201b, 201d, 201f, and 201h). In this case, the first element group is connected to the right ground electrode 206 through the power supply wiring 205, and the second element group is connected to the left ground electrode 206b through the power supply wiring 205. In other words, in the present embodiment, discharge elements 201 included in a discharge element row are connected to different ground electrodes 206 alternatingly. Furthermore, drive wiring 209 is connected to each discharge element 201 on a lateral side opposite to the side where the power supply wiring 205 is not connected.

In this manner, by distributing discharge elements 201 connected to the ground electrode 206, voltage drop can be sufficiently reduced. Note that the method of distributing the discharge elements 201 is not limited to the method of distributing the discharge elements 201 alternatingly one by one. For example, a method of distributing adjacent discharge elements two by two may be employed as described later. In addition, any method that can reduce wiring resistance as compared to the conventional case by distributing discharge elements 201 to appropriate different ground electrodes 206 may be employed.

As described above, in the present embodiment, each ground electrode 206 is disposed near the discharge element 201, so that the layout is implemented such that the power supply wiring 205 is short. Furthermore, in a discharge element row, each discharge element 201 is connected to a ground electrode 206 different from an adjacent discharge element 201. As a result, voltage drop in each power supply electrode 204 and the power supply wiring 205 can be sufficiently reduced. In this manner, the efficiency of electric energy supplied to the plurality of discharge elements 201 is improved.

### Embodiment 3

In the present embodiment, another example of a connection combination of a plurality of discharge elements 101 (or 201) arranged in a row, the power supply wiring 105 (or 205), and the drive wiring 109 (or 209) as described in Embodiment 1 and Embodiment 2 is described.

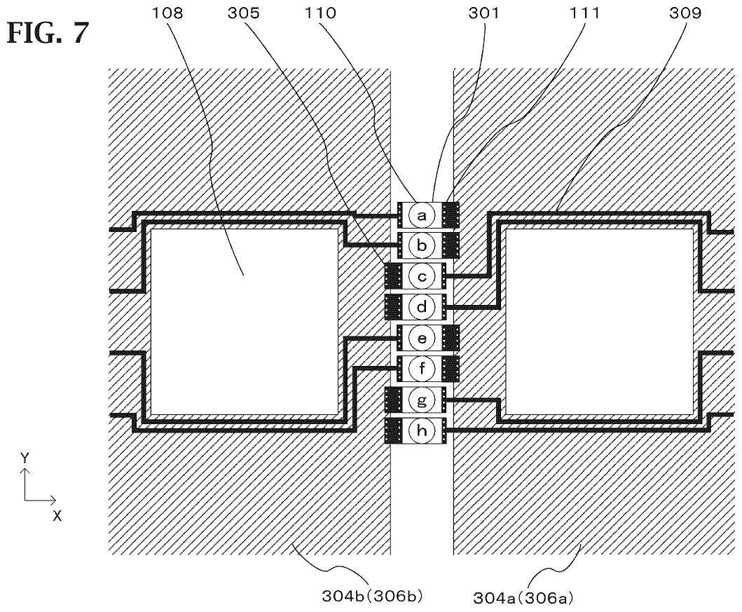

FIG. 7 is a partially enlarged plan view of the vicinity of the discharge element 301 in the present embodiment. The schematic configuration diagram of the discharge element substrate 300 and description thereof are omitted because these are the same as in the description in Embodiment 1 or Embodiment 2 except for a combination of a plurality of discharge elements 301, the power supply wiring 305, and the drive wiring 309 to be connected.

In the present embodiment, a plurality of discharge elements 301 are arranged in a row, and a freely selected discharge element 301 and its adjacent discharge element 301 constitute each group. Each group of discharge elements 301 and each group of adjacent discharge elements 301 are connected to any one of the left and right power supply electrodes 304 through the power supply wiring 305. In this example, the adjacent discharge elements 301a and 301b as a pair are connected to the right power supply electrode 304a. Similarly, the discharge elements 301c and 301d are connected to the left power supply electrode 304b, the discharge elements 301e and 301f are connected to the right power supply electrode 304a, and the discharge elements 301g and 301h are connected to the left power supply electrode 304b. Furthermore, drive wiring 309 is connected to each discharge element 301 on the side where the power supply wiring 305 is not connected.

Note that the above description is applied when the power supply electrode 304 is disposed on the inner side in the X direction as in Embodiment 1. On the other hand, when the ground electrode 306 is disposed on the inner side in the X direction as in Embodiment 2, the discharge elements 301a, 301b, 301e, and 301f are connected to the right ground electrode 306a, and the discharge elements 301c, 301d, 301g, and 301h are connected to the left ground electrode 306b.

In this manner, by distributing discharge elements 301 connected to power supply electrodes 304, voltage drop in the power supply electrode 304 can be sufficiently reduced. Furthermore, in the present embodiment, each group includes two discharge elements 301, but each group may include three or more discharge elements 301, and each group of discharge elements 301 and each group of adjacent discharge elements 301 may be connected to any one of the left and right power supply electrodes 304 through the power supply wiring 305.

As described above, in the case where the configuration in the present embodiment is applied to the layout in Embodiment 1, each power supply electrode 304 is disposed near the discharge element 301. In this manner, the layout can be implemented such that the power supply wiring 305 is short. Furthermore, each group of discharge elements 301 and each group of adjacent discharge elements 301 are connected to any one of the left and right power supply electrodes 304 so as to be alternatingly disposed. As a result, voltage drop in the power supply electrode 304 and the power supply wiring 305 can be sufficiently reduced.

Furthermore, in the case where the configuration in the present embodiment is applied to the layout in Embodiment 2, each ground electrode 306 is disposed near the discharge element 301. In this manner, the layout can be implemented such that the power supply wiring 305 is short. Furthermore, each group of discharge elements 301 and each group of adjacent discharge elements 301 are connected to any one of the left and right ground electrodes 306 so as to be alternatingly disposed. As a result, voltage drop in the power supply electrode 304 and the power supply wiring 305 can be sufficiently reduced.

As described above, the configuration in the present embodiment improves the efficiency of electric energy supplied to the plurality of discharge elements 301.

### Embodiment 4

In the present embodiment, an example in which the discharge element substrate 100 (200, 300) described in Embodiment 1 to Embodiment 3 is applied to a recording apparatus is described.

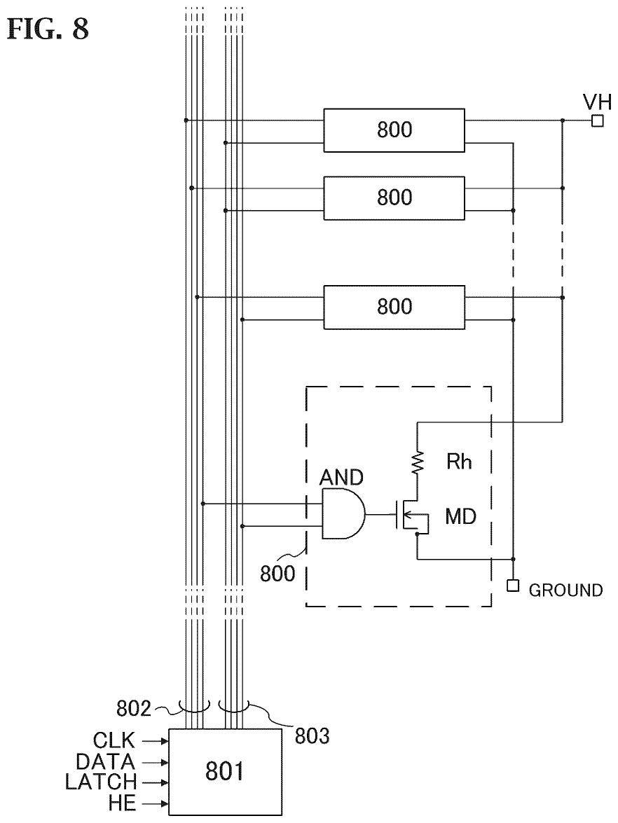

FIG. 8 illustrates an example of a circuit configuration of a recording head substrate having the discharge element 101 (201, 301) described in Embodiment 1 to Embodiment 3.

A recording portion 800 has a heater resistor Rh and a drive portion (for example, transistor MD and logical AND circuit AND) for driving the heater resistor Rh. By driving the heater resistor Rh (that is, by energizing the heater resistor Rh to generate heat), a recording agent such as ink is discharged to perform recording.

The control circuit 801 can be configured by, for example, a shift register or a latch circuit (not shown). For example, a clock signal CLK, an image data signal DATA, a latch signal LT, and a heater control signal HE may be input to the control circuit 801 through a host PC (not shown). Furthermore, a power supply voltage VDD (for example, 3 to 5 V) is supplied to the logical AND circuits AND and NAND and the control circuit 801 as a logic power supply voltage. Thus, the heater resistor Rh in the recording portion 800 is electrically connected to the control circuit 801.

Here, for example, for m groups each having n recording portions 800, the control circuit 801 can perform time-division driving to control the operation of the recording portions 800 for each group to drive the heater resistor Rh. In the time-division driving, the control circuit 801 outputs an m-bit group selection signal 802 for selecting m groups and an n-bit block selection signal 803 for selecting n recording portions 800 in the group.

To the logical AND circuit AND, a corresponding group selection signal 802 and a block selection signal 803 are input, and when both signals are in the ON state, the transistor MD is turned ON. When the transistor MD is in the ON state, the heater resistor Rh connected in series is driven. In the recording portion 800, a power supply voltage VH (for example, 24 V) is supplied as a heater driving power supply voltage, and the ground potential is set to ground GND. The power supply voltage VH is connected to the power supply electrode 104, and the ground GND is connected to the ground electrode 106.

To the logical AND circuit NAND, a control signal 804 and a block selection signal 803 are input, and corresponding signal is output from an inverter to the transistor MD, thereby switching the ON/OFF state of the transistor MD.

In FIG. 8, the configuration in which the recording portions 800 are all connected to the control circuit 801 is illustrated, but the recording portions 800 may be connected to different control circuits.

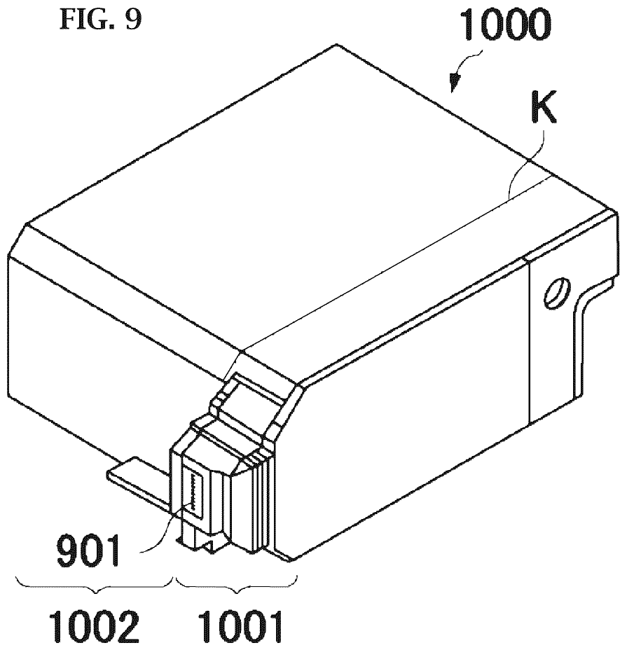

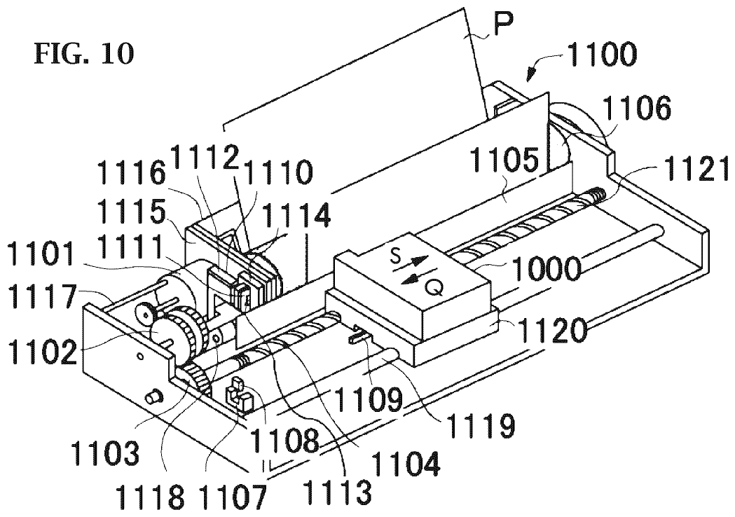

Referring to FIG. 9 and FIG. 10, as an example in which the above-mentioned recording head substrate is mounted in a recording apparatus is described by way of an inkjet recording type. However, the recording apparatus is not limited to this type, and, for example, may be a thermal transfer type recording apparatus such as a melting type or a sublimation type. The recording apparatus may be a single-function printer having only a recording function, or may be a multi-function printer having a plurality of functions such as a recording function, a FAX function, and a scanner function. Furthermore, the recording apparatus may be a manufacturing apparatus for manufacturing a color filter, an electronic device, an optical device, and a microstructure by a predetermined recording type.

“Recording” includes not only the case where matters that can be visually perceived by humans, such as an image, a design, a pattern, and a structure are formed on a recording medium but also the case where a medium is processed. A “recording medium” includes not only paper used for a general recording apparatus but also the one that can be applied with a cloth, a plastic film, a metal plate, glass, ceramics, resin, wood, leather, and a recording agent. A “recording agent” includes not only liquid such as ink that can be applied to a recording medium so as to be used for forming of an image, a design, and a pattern or processing of the recording medium but also liquid that can be used for processing of a recording agent (for example, solidification or insolubilization of color agent contained in recording agent).

FIG. 9 illustrates the appearance of a recording head 1000. The recording head 1000 may include a recording head portion 1001 having a discharge element substrate 100 including a plurality of discharge ports 110, and an ink tank 1002 attached to the recording head portion 1001. The ink tank 1002 holds ink to be supplied to the recording head portion 1001. The ink tank 1002 and the recording head portion 1001 can be separated from each other by, for example, a broken line K, so that the ink tank 1002 can be replaced.

The recording head 1000 includes an electric contact (not shown) for receiving an electric signal from a carriage 1120 (FIG. 10), and discharges ink in accordance with the electric signal to perform the above-mentioned recording. The ink tank 1002 has, for example, a fibrous or porous ink holding material (not shown), and can hold ink by the ink holding material.

FIG. 10 is a perspective view of the recording apparatus 1100. The recording head 1000 is the recording head partially illustrated in FIG. 9, and can be mounted on the carriage 1120 together with an ink tank (recording agent container). The carriage 1120 is attached to a lead screw 1104 having a screw groove 1121. By the rotation of the lead screw 1104, the recording head 1000 can move in the direction of an arrow S or an arrow Q along a guide 1119 together with the carriage 1120. The rotation of the lead screw 1104 is synchronous with the rotation of a drive motor 1101 through drive power transmission gears 1102 and 1103.

Recording paper P can be transported onto a platen 1106 by a transport portion (not shown). A paper press plate 1105 can press the recording paper P against the platen 1106 along the carriage movement direction. The recording apparatus 1100 can check the position of a lever 1109 provided to the carriage 1120 through photocouplers 1107 and 1108, and switch the rotation direction of the drive motor 1101. A support member 1110 can support a cap member 1111 for capping each nozzle in the recording head 1000. Suction means 1112 can suck the inside of the cap member 1111 to perform suction restore processing in the recording head 1000 through a cap internal opening 1113.

As a cleaning blade 1114, a well-known cleaning blade is used, and a movement member 1115 can move the cleaning blade 1114 in the front-back direction. A main body support plate 1116 can support the movement member 1115 and the cleaning blade 1114. The lever 1117 is provided for starting the suction restore processing.

The lever 1117 moves along with the movement of a cam 1118 engaged with the carriage 1120. Drive power from the drive motor 1101 can be controlled by publicly known transmission means such as a clutch switch. The recording apparatus 1100 is provided with a recording control portion (not shown), and the recording apparatus 1100 can control the driving of each mechanism in accordance with an electric signal such as recording data from the outside. The recording apparatus 1100 repeats the reciprocating of the recording head 1000 and the transport of the recording paper P by the transport portion (not shown), thereby completing the recording on the recording paper P.

Furthermore, the above-mentioned recording apparatus can be used as an apparatus having 3D data to form a three-dimensional image.

As described above, by applying the discharge element substrate 100 (200, 300) in Embodiment 1 to Embodiment 3 to a recording apparatus, voltage drop caused by the power supply electrode and the wiring resistance can be minimized to improve the producibility of the recording apparatus.

In each embodiment, the power supply electrode 104 is a common power supply electrode that is connected in common to a plurality of discharge elements. The ground electrode 106 is also a common power supply electrode that is connected in common to a plurality of discharge elements. The power supply electrode 104 and the ground electrode 106 can be referred to as “first electrode” and “second electrode”, respectively. When the power supply electrode 104 is a first electrode, the ground electrode 106 is a second electrode. On the other hand, when the ground electrode 106 is a first electrode, the power supply electrode 104 is a second electrode. In the embodiments, at least one of the power supply electrode 104 and the ground electrode 106 is formed as plane wiring, and hence the wiring distance between the electrode and the discharge element 101 can be reduced. The first electrode (the power supply electrode 104 or the ground electrode 106) is a common electrode connected to the plurality of discharge elements in common along the first direction of the substrate.

As described above, in the conventional case where a feeding port is disposed between a discharge element and a power supply electrode, power supply wiring that connects the discharge element and the power supply electrode is long, and voltage drop occurs due to wiring resistance that increases depending on the length of the wiring, which is a problem in terms of power efficiency of the discharge element. Thus, as described in each embodiment in the present application, the power supply electrode is disposed near the discharge element such that power supply wiring is short, and hence voltage drop due to wiring resistance can be reduced to improve efficiency of electric energy for driving a heater.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-046218, filed on Mar. 22, 2024, which is hereby incorporated by reference wherein in its entirety.

What is claimed is:

1. A discharge element substrate, comprising:
a plurality of discharge elements configured to discharge liquid housed in a liquid chamber from a discharge port by energy generated by an energy element provided to a substrate;
a first electrode configured to apply voltage to the plurality of discharge elements;
a selection circuit configured to select any one of the plurality of discharge elements; and
a second electrode configured to apply voltage to the discharge element selected by the selection circuit such that the discharge element is caused to discharge liquid, wherein:
the plurality of discharge elements are arranged along a first direction; and
the first electrode is connected to the plurality of discharge elements in common along the first direction of the substrate.

2. The discharge element substrate according to claim 1, wherein two first electrodes are formed in parallel so as to sandwich the plurality of discharge elements arranged along the first direction.

3. The discharge element substrate according to claim 2, wherein:
a part of the plurality of discharge elements are connected to one of the first electrodes; and
a remaining part of the plurality of discharge elements are connected to the other of the first electrodes.

4. The discharge element substrate according to claim 3, wherein the plurality of discharge elements are connected to the one of the first electrodes and the other of the first electrodes alternatingly.

5. The discharge element substrate according to claim 3, wherein the plurality of discharge elements are distributed to the one of the first electrodes and the other of the first electrodes with a group of a predetermined number of discharge elements.

6. The discharge element substrate according to claim 3, wherein two second electrodes are formed in parallel along the first direction so as to further sandwich the two first electrodes.

7. The discharge element substrate according to claim 6, further comprising a plurality of drive circuits corresponding to the plurality of discharge elements, respectively, wherein:
the selection circuit is configured to select, from among the plurality of drive circuits, the drive circuit corresponding to the discharge element to be driven; and
the second electrode is configured to apply voltage to the discharge element through the selection circuit and the drive circuit.

8. The discharge element substrate according to claim 1, wherein, in each of the plurality of discharge elements, a distance to the first electrode is smaller than a distance to the second electrode.

9. The discharge element substrate according to claim 1, wherein the first electrode is a power supply electrode, and the second electrode is a ground electrode.

10. The discharge element substrate according to claim 1, wherein the first electrode is a ground electrode, and the second electrode is a power supply electrode.

11. The discharge element substrate according to claim 1, wherein the first electrode is divided into a plurality of electrodes in the first direction.

12. A recording apparatus, comprising a recording head including a discharge element substrate, wherein:
the discharge element substrate comprises:
a plurality of discharge elements configured to discharge liquid housed in a liquid chamber from a discharge port by energy generated by an energy element provided to a substrate;
a first electrode configured to apply voltage to the plurality of discharge elements;
a selection circuit configured to select any one of the plurality of discharge elements; and
a second electrode configured to apply voltage to the discharge element selected by the selection circuit such that the discharge element is caused to discharge liquid, wherein:
the plurality of discharge elements are arranged along a first direction;
the first electrode is connected to the plurality of discharge elements in common along the first direction of the substrate; and
an image is recorded on a recording material by liquid discharged from the discharge element substrate.
